(19) United States
(12) Patent Application Publication
(10) Pub. No.: US 2008/0294699 A1
(43) Pub. Date: Nov. 27, 2008

(54) ONLINE ADVERTISING METHOD AND SYSTEM WHICH REFLECTS UPDATE OF DATABASE IN REAL TIME

(75) Inventors: Suk Ku Yu, Gyeonggi-do (KR); EunJa Byun, Gyeonggi-do (KR)

Correspondence Address: HUSCH BLACKWELL SANDERS LLP, 720 OLIVE STREET, SUITE 2400, ST. LOUIS, MO, 63101, US

(73) Assignee: NHN CORPORATION, Kyunggi-do (KR)

(21) Appl. No.: 12/062,609

(22) Filed: Apr. 4, 2008

(30) Foreign Application Priority Data
Apr. 6, 2007 (KR) 10-2007-0034143

(51) Int. Cl. G06F 17/30

(52) U.S. Cl. 707/200; 707/E17.005

(57) ABSTRACT

An online advertising method and system which automatically reflects update of a database due to new content data, generated in an online service, in advertising data associated with the online service. The method of the present invention comprises the steps of: identifying new content data associated with an online service; updating a database with at least some of the new content data; and automatically reflecting changes in the database in advertising data associated with the online service.

### CROSS-REFERENCE TO RELATED APPLICATION

This application claims the benefit of Korean Patent Application No. 10-2007-0034143, filed on Apr. 6, 2007, in the Korean Intellectual Property Office, the disclosure of which is incorporated herein by reference.

### BACKGROUND OF THE INVENTION

1. Field of the Invention

The present invention relates to an online advertising method and system which reflects update of a database in real time, and more particularly, to an online advertising method and system which reflects update of a database due to new content data, generated in an online service, in advertising data associated with the online service in real time.

2. Description of Related Art

Internet-based advertising is widely used, and online advertising associated with a variety of online services such as a search service, movie service, board service, user-created content (UCC) service, and the like, is now generally used in various kinds of web-pages such as a portal site and game site.

For example, in a conventional online advertising method, when displaying a search result to a user in a portal site, a banner advertisement is displayed in a fixed location. In the method, a banner advertisement including an advertising message or image is displayed in a predetermined location of a webpage, and accounting is based on the number of exposures of the banner advertisement or the number of times that a user clicks the banner advertisement. Currently, the banner advertisement is made using an animated GIF, Flash, or Java, and thus an animated image may be provided. However, in the conventional online advertising method, since a banner advertisement shows a same image, a user may not be interested in the banner advertisement once the user has seen the advertisement. Accordingly, an advertising effect may not be improved.

In a conventional art, an online advertising service method in association with a movie service provides a banner including a promotion video about a newly-released film. Generally, a user using a movie service selects a movie to see considering a critic's review or people's review, as opposed to considering a banner advertisement of a newly-released film. Also, a conventional banner including a promotion video does not provide a user with updated reviews in real time. Accordingly, a user is required to find reviews on his/her own.

In a conventional art, an online advertising service method in association with a board service provides a banner. In the method, a banner is provided in a fixed location of a webpage associated with a board, and thus the banner is exposed to a user when the user checks postings on the board. In the method, accounting is based on the number of times that the board is checked or the number of times that the user accesses to the webpage.

A variety of online advertising methods including the above-described online advertising methods are used. Also, new online advertising methods are being developed to improve an advertising effect and increase an acceptance with respect to advertising.

### BRIEF SUMMARY OF THE INVENTION

The present invention provides an online advertising method and system which reflects update of a database due to new content data, generated in an online service, in advertising data associated with the online service in real time.

The present invention also provides an online advertising method and system which, when data such as a rating and review with respect to a movie is updated in a movie service, reflects the updated data in advertising data associated with the updated data in real time.

The present invention also provides an online advertising method and system which reflects user-created content (UCC) in advertising data associated with the UCC in real time in a UCC service.

The present invention also provides an online advertising method and system which, when a posting on a board or reply message is updated, exposes the updated posting or reply message to advertising data associated with the updated posting or reply message in real time.

The present invention also provides an online advertising method and system which enables a reply function with respect to advertising data to be provided.

According to an aspect of the present invention, there is provided an online advertising method, including the steps of: identifying new content data associated with an online service; updating a database with at least some of the new content data; and automatically reflecting changes in the database in advertising data associated with the online service.

According to another aspect of the present invention, there is provided an online advertising system, including: an online service providing component configured to provide an online service; an update component configured to update a database with at least some of new content data associated with the online service; and an advertising management component configured to automatically reflect changes in the database in advertising data associated with the online service.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a block diagram illustrating a configuration of an online advertising system according to an exemplary embodiment of the present invention;

FIG. 2 is a diagram illustrating an interoperation of an advertising database with respect to an online service and online advertisement according to an exemplary embodiment of the present invention;

FIG. 3 is a diagram illustrating an example of an online advertisement associated with an online movie service according to an exemplary embodiment of the present invention;

FIG. 4 is a diagram illustrating an example of an online advertisement associated with a service of providing user-created content (UCC) according to an exemplary embodiment of the present invention;

FIG. 5 is a diagram illustrating an example of an online advertisement associated with an online board service according to an exemplary embodiment of the present invention;

FIG. 6 is a flowchart illustrating an online advertising method according to another exemplary embodiment of the present invention;

FIG. 7 is a flowchart illustrating an example of a method of updating new content data in a database according to another exemplary embodiment of the present invention; and

FIG. 8 is a flowchart illustrating an example of a method of reflecting updated new content data in advertising data associated with an online service in real time according to another exemplary embodiment of the present invention.

### DETAILED DESCRIPTION OF THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a module. One or more components can reside within a process and/or thread of execution, and a module or component can be localized on one computer and/or distributed between two or more computers.

As used herein, the terms “desktop,” “PC,” “local computer,” and the like, refer to computers on which systems (and methods) according to the invention operate. In the illustrated embodiments, these are personal computers, such as portable computers and desktop computers; however, in other embodiments, they may be other types of computing devices (e.g., workstations, mainframes, personal digital assistants or PDAs, music or MP3 players, and the like).

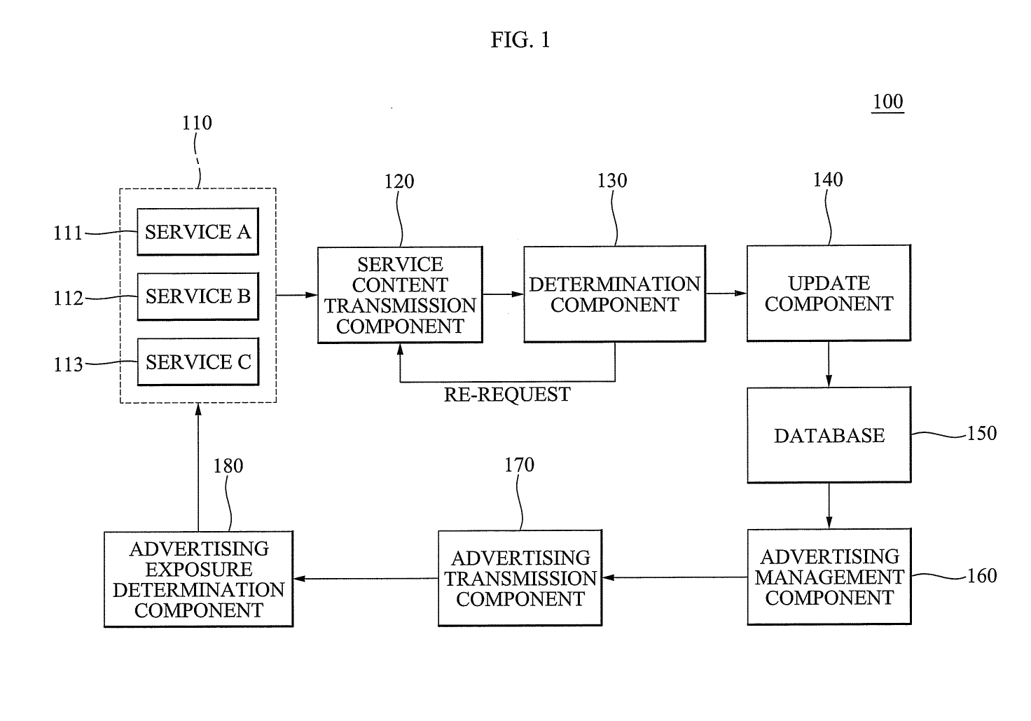

FIG. 1 is a block diagram illustrating a configuration of an online advertising system 100 according to an exemplary embodiment of the present invention.

Referring to FIG. 1, the online advertising system 100 includes an online service providing component 110, service content transmission component 120, determination component 130, update component 140, database 150, advertising management component 160, advertising transmission component 170, and advertising exposure determination component 180.

The online service providing component 110 provides a variety of online services such as a service A 111, service B 112, and service C 113. The variety of online services may be provided in various portal sites or websites connected via the Internet. For example, the variety of online services may be a service providing a user evaluation of a movie, concert, game, and the like. Also, the variety of online services may be a service to expose and activate user-created content (UCC) in association with a UCC service. Also, the variety of online services may be a service providing an event promotion associated with a board such as sending a message of support or love confession. Also, the variety of online services may be a service providing information on stocks, sports events, and the like, in real time.

The service content transmission component 120 transmits new content data of the online services, provided in the online service providing component 110, to the determination component 130. The new content data includes various types of data such as a text, video, photo, and the like. That is, the service content transmission component 120 transmits the new content data generated in the online services to the determination component 130.

For example, when the online service providing component 110 provides a user evaluation online service about the movie, concert, game, and the like, the service content transmission component 120 may transmit new content data generated in the user evaluation online service to the determination component 130.

For another example, when the online service providing component 110 provides a UCC-related online service, the service content transmission component 120 may transmit new content data generated in the UCC-related online service to the determination component 130.

For another example, when the online service providing component 110 provides an event promotion online service such as sending the message of support, love confession, and the like, the service content transmission component 120 may transmit new content data generated in the event promotion online service to the determination component 130. In this instance, the event promotion online service is associated with a board.

For another example, when the online service providing component 110 provides a real-time information online service associated with information on stocks, sports events, and the like, the service content transmission component 120 may transmit new content data generated in the real-time information online service to the determination component 130.

The determination component 130 determines whether to update the new content data transmitted by the service content transmission component 120.

For example, when the new content data according to the user evaluation online service is transmitted, the determination component 130 determines whether to update the new content data according to the user evaluation online service.

For another example, when the new content data according to the UCC-related online service is transmitted, the determination component 130 determines whether to update the new content data according to the UCC-related online service.

For still another example, when the new content data according to the event promotion online service is transmitted, the determination component 130 determines whether to update the new content data according to the event promotion online service.

For yet another example, when the new content data according to the real-time information online service is transmitted, the determination component 130 determines whether to update the new content data according to the real-time information online service.

The new content data is determined to be updated, the determination component 130 requests the update component 140 that the new content data is updated in the database 150.

For example, when the new content data according to the user evaluation online service is determined to be updated, the determination component 130 requests the update component 140 that the new content data according to the user evaluation online service is updated in the database 150.

For another example, when the new content data according to the UCC-related online service is determined to be updated, the determination component 130 requests the update component 140 that the new content data according to the UCC-related online service is updated in the database 150.

For still another example, when the new content data according to the event promotion online service is determined to be updated, the determination component 130 requests the update component 140 that the new content data according to the event promotion online service is updated in the database 150.

For yet another example, when the new content data according to the real-time information online service is determined to be updated, the determination component 130 requests the update component 140 that the new content data according to the real-time information online service is updated in the database 150.

Also, when the new content data is not determined to be updated, the determination component 130 re-requests a transmission of the new content data to the service content transmission component 120.

For example, when the new content data according to the user evaluation online service is not determined to be updated, the determination component 130 re-requests a transmission of the new content data according to the user evaluation online service to the service content transmission component 120.

For another example, when the new content data according to the UCC-related online service is not determined to be updated, the determination component 130 re-requests a transmission of the new content data according to the UCC-related online service to the service content transmission component 120.

For still another example, when the new content data according to the event promotion online service is not determined to be updated, the determination component 130 re-requests a transmission of the new content data according to the event promotion online service to the service content transmission component 120.

For yet another example, when the new content data according to the real-time information online service is not determined to be updated, the determination component 130 re-requests a transmission of the new content data according to the real-time information online service to the service content transmission component 120.

The update component 140 updates the new content data, generated in the online service, in the database 150. That is, when the update of the new content data according to the online service is requested from the determination component 130, the update component 140 updates the new content data in the database 150.

For example, the update component 140 may update the new content data according to the user evaluation online service in the database 150 according to the request from the determination component 130.

For another example, when update of the new content data according to the UCC-related online service is requested from the determination component 130, the update component 140 may update the new content data according to the UCC-related online service in the database 150.

For another example, when update of the new content data according to the event promotion online service is requested, the update component 140 may update the new content data according to the event promotion online service in the database 150.

For another example, when update of the new content data according to the real-time information online service is requested, the update component 140 may update the new content data according to the real-time information online service in the database 150.

The database 150 stores and maintains data associated with the online service. That is, the database 150 updates the new content data which is generated in the online service by the update component 140. For example, the database 150 may update the new content data according to the user evaluation online service by the update component 140. For another example, the database 150 may be updated with the new content data according to the UCC-related online service by the update component 140. For still another example, the database 150 may be updated with the new content data according to the event promotion online service by the update component 140. For yet another example, the database 150 may be updated with the new content data according to the real-time promotion online service by the update component 140.

The advertising management component 160 manages an online advertisement to reflect the updated new content data in advertising data associated with the online service corresponding to the updated new content data in real time. Specifically, the advertising management component 160 checks for updates of the database 150 periodically, in order to reflect the updated new content data in real time. Also, the advertising management component 160 reads updated database values and manages the online advertisement to reflect the updated new content data in the advertising data associated with the online service.

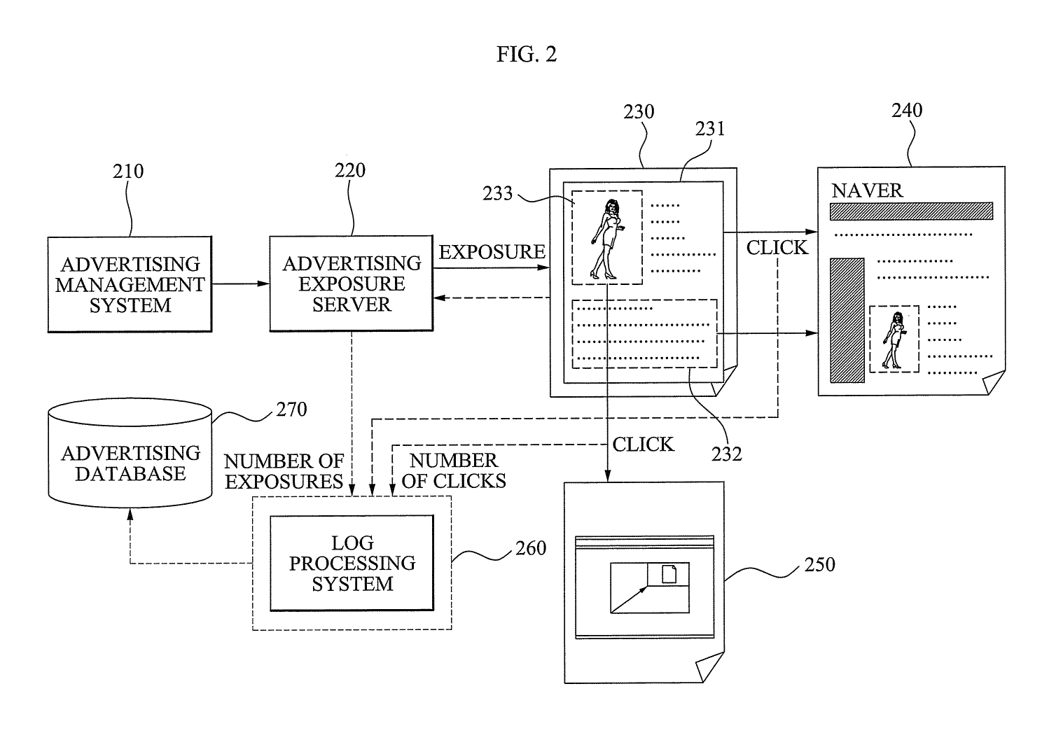

FIG. 2 is a diagram illustrating an interoperation of advertising database with respect to an online service and online advertisement according to an exemplary embodiment of the present invention.

Referring to FIG. 2, an advertising management system 210 manages a variety of online advertisements. Also, an advertising exposure server 220 exposes an online advertisement associated with a variety of online services and receives feedback about exposure information about the online advertisement.

An online advertisement 230 is an example of the online advertisement exposed to a user through the advertising exposure server 220. Online service information 231 is illustrated as an example of online service information associated with the online advertisement 230. Postings 232 are illustrated as an example of posting information according to the online service. An image 233 is an example of an image according to the online service.

A webpage 240 is an example of a webpage provided with the online service associated with the online advertisement service, when a user that sees the online advertisement clicks the online service information 231 or postings 232.

A website 250 is an example of a website of an advertiser of the online advertisement service, when the user that sees the online advertisement clicks the image 233.

A log processing system 260 processes log information such as a number of exposures and a number of clicks according to the online advertisement. An advertising database 270 stores and maintains data associated with the online advertisement.

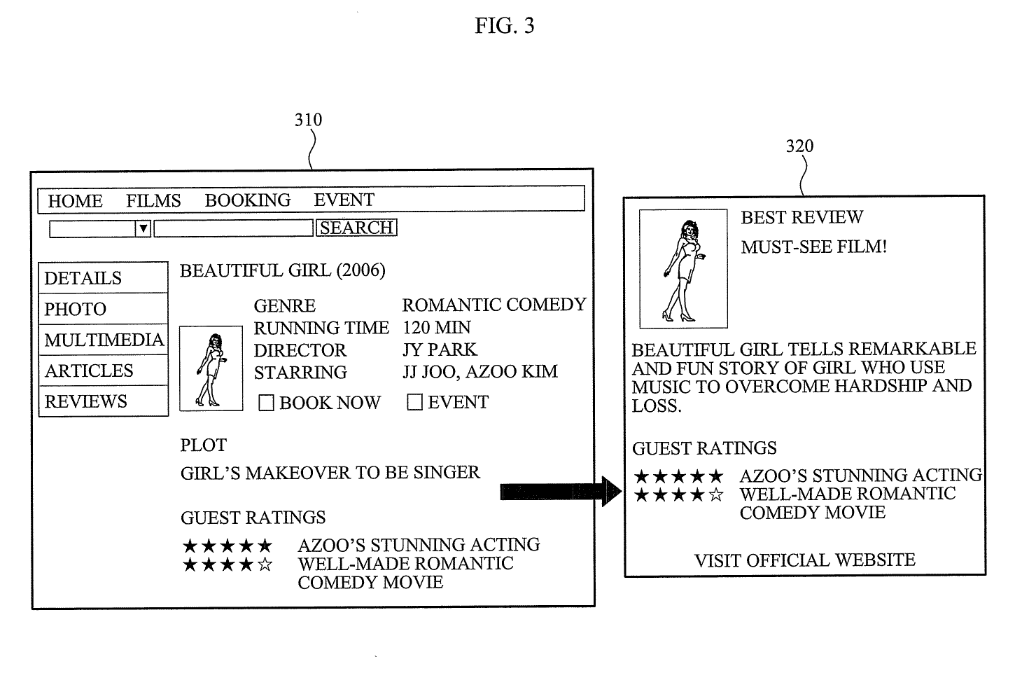

FIG. 3 is a diagram illustrating an example of an online advertisement 320 associated with an online movie service according to an exemplary embodiment of the present invention.

Referring to FIG. 3, a webpage 310 is an example when an online service is a movie service, and an online advertisement 320 is an example of an online advertisement associated with the movie service.

When new content data is updated in the movie service, an advertising management component 160 manages the online advertisement 320 to reflect the updated new content data in advertising data associated with the movie service in real time. For example, the advertising management component 160 may manage the online advertisement 320 in a way of reading a database value to a Flash banner at regular periods in order to reflect new content data according to the movie service in the online advertisement 320 associated with the movie service in real time. The database value is stored in a database 150.

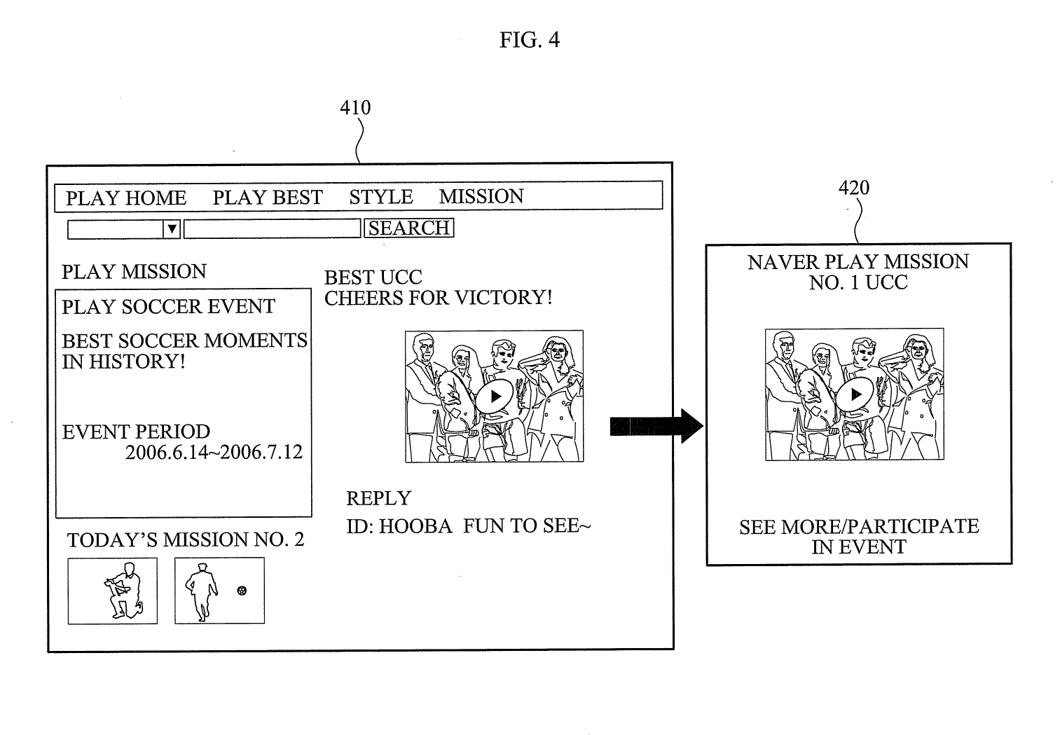

FIG. 4 is a diagram illustrating an example of an online advertisement 420 associated with a service of providing UCC according to an exemplary embodiment of the present invention.

Referring to FIG. 4, a webpage 410 is an example of when an online service is the service of providing UCC, and an online advertisement 420 is an example of an online advertisement associated with the service of providing UCC.

When new content data is updated in the service of providing UCC, an advertising management component 160 manages the online advertisement 420 to reflect the updated new content data in advertising data associated with the service of providing UCC in real time. For example, the advertising management component 160 may manage the online advertisement 420 in a way of reading a database value in a Flash banner at regular periods in order to reflect new content data according to the service of providing UCC in the online advertisement 420 associated with the service of providing UCC in real time. The database value is stored in a database 150.

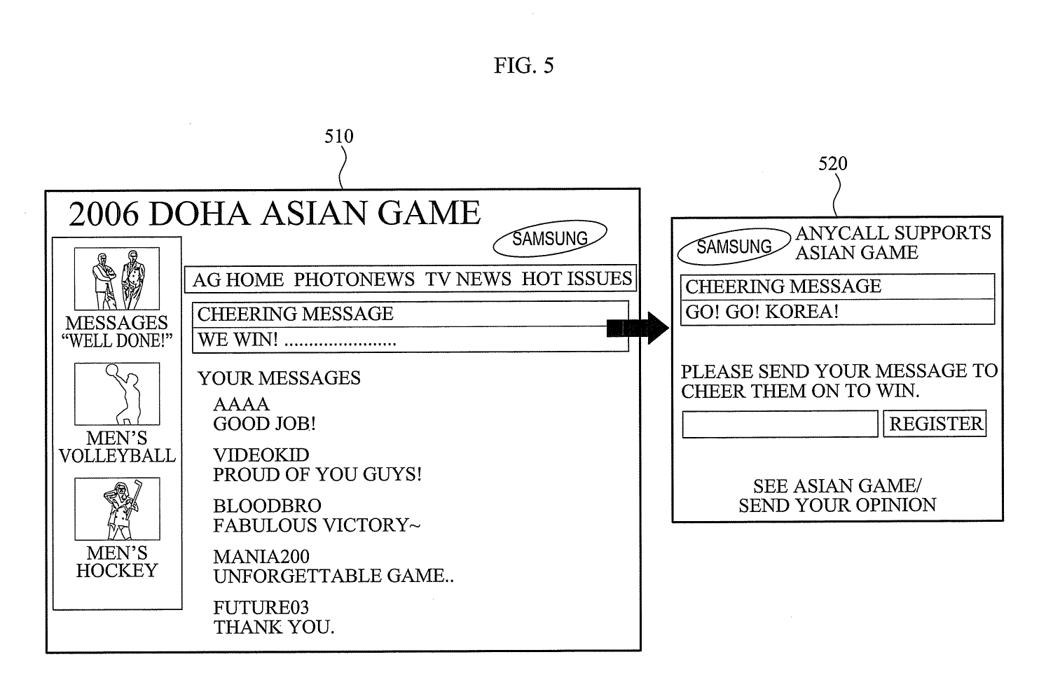

FIG. 5 is a diagram illustrating an example of an online advertisement 520 associated with an online board service according to an exemplary embodiment of the present invention.

Referring to FIG. 5, a webpage 510 is an example of when an online service is the online board service, and an online advertisement 520 is an example of an online advertisement associated with the online board service.

When new content data is updated in the online board service, an advertising management component 160 manages the online advertisement 520 to reflect the updated new content data in advertising data associated with the online board service in real time. For example, the advertising management component 160 may manage the online advertisement 520 in a way of reading a database value in a Flash banner at regular periods in order to reflect new content data according to the online board service in the online advertisement 520 associated with the online board service in real time. The database value is stored in a database 150.

Also, when the advertising data includes an opinion registration function, the advertising management component 160 may manage the online advertisement 520 to reflect opinion data in the advertising data associated with the online service in real time. The opinion data is registered based on the opinion registration function.

An advertising transmission component 170 transmits the new content data to be reflected in the advertising data associated with the online service, to an advertising exposure determination component 180. As an example of new content data to be reflected in advertising data associated with a movie service, when movie review data according to the movie service is updated, the updated movie review data may be transmitted to the advertising exposure determination component 180. For another example, as new content data to be reflected in advertising data associated with a service of providing UCC, when UCC data according to the service of providing UCC is updated, the updated UCC data may be transmitted to the advertising exposure determination component 180. For still another example, as new content data to be reflected in advertising data associated with the online board service, when reply data according to the online board service is updated, the updated reply data may be transmitted to the advertising exposure determination component 180.

The advertising exposure determination component 180 determines whether to expose the online advertisement with the updated new content data. Also, the advertising exposure determination component 180 controls the updated new content data to be reflected in the advertising data associated with the online service in real time depending on whether to expose the online advertisement. That is, when whether to expose the online advertisement with respect to the updated new content data is determined, the advertising exposure determination component 180 controls the updated new content data to be reflected in the advertising data in real time.

For example, when a service A 111 is the movie service, the advertising exposure determination component 180 determines whether to expose the online advertisement with respect to the updated movie review data according to the movie service. Also, the advertising exposure determination component 180 controls the updated movie review data to be reflected in advertising data associated with the service A 111 in real time according to the determination.

For another example, when a service B 112 is the service of providing UCC, the advertising exposure determination component 180 determines whether to expose the online advertisement with respect to the updated UCC data according to the service of providing UCC. Also, the advertising exposure determination component 180 controls the updated UCC data to be reflected in advertising data associated with the service B 112 in real time according to the determination.

For still another example, when a service C 113 is the online board service, the advertising exposure determination component 180 determines whether to expose the online advertisement with respect to the updated reply data according to the online board service. Also, the advertising exposure determination component 180 controls the updated reply data to be reflected in advertising data associated with the service C 113 in real time according to the determination.

Also, when whether to expose the online advertisement with respect to the updated new content data is not determined, the advertising exposure determination component 180 exposes a default advertisement to the advertising data associated with the online service.

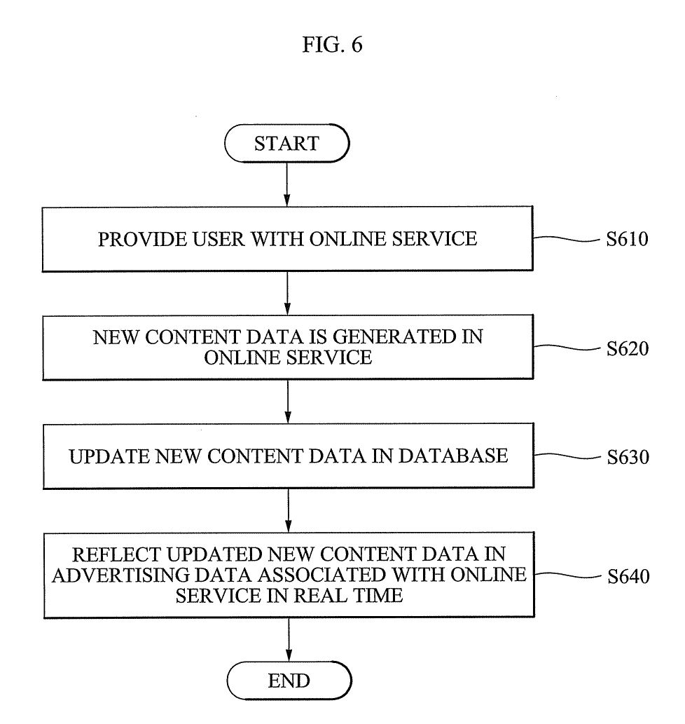

FIG. 6 is a flowchart illustrating an online advertising method according to another exemplary embodiment of the present invention.

Referring to FIG. 6, in operation S610, a system for providing an online service provides a user with an online service. That is, the system for providing an online service provides the user with an online advertisement associated with the online service. The online service may be provided in various portal sites or websites connected via the Internet. For example, the online service may be a service providing a user evaluation of a movie, concert, game, and the like. Also, the online service may be a service to expose and activate UCC in association with a UCC service. Also, the online service may be a service providing event promotion associated with a board such as sending a message of support or love confession. Also, the online service may be a service providing information on stocks, sports events, and the like, in real time.

In operation S620, new content data is generated in the online service. That is, the system for providing an online service receives the new content data inputted by the user according to the online service in operation S620.

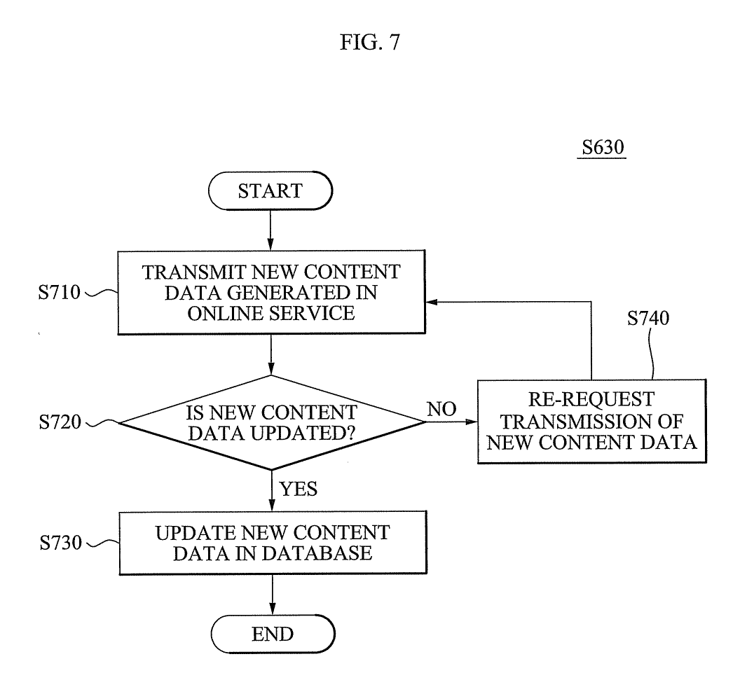

In operation S630, the system for providing an online service updates the new content data in a database. The database stores and maintains data of the online service and data of an online advertisement. A method of updating the new content data with respect to the online service in the database is described in greater detail with reference to FIG. 7.

FIG. 7 is a flowchart illustrating an example of a method of updating new content data in a database according to another exemplary embodiment of the present invention.

Referring to FIG. 7, in operation S710, the system for providing an online service transmits the new content data, generated in the online service, to an online advertising system.

In operation S720, the online advertising system determines whether the new content data is updated.

For example, new content data according to a user evaluation online service is transmitted, the online advertising system determines whether to update the new content data according to the user evaluation online service in operation S720.

For another example, new content data according to a UCC-related online service is transmitted, the online advertising system determines whether to update the new content data according to the UCC-related online service in operation S720.

For still another example, new content data according to an event promotion online service is transmitted, the online advertising system determines whether to update the new content data according to the event promotion online service in operation S720.

For yet another example, new content data according to a real-time information online service is transmitted, the online advertising system determines whether to update the new content data according to the real-time information online service in operation S720.

When the new content data is determined to be updated, the online advertising system updates the new content data in the database in operation S730.

For example, when the new content data according to the user evaluation online service is determined to be updated, the online advertising system updates the new content data according to the user evaluation online service in the database in operation S730.

For another example, when the new content data according to the UCC-related online service is determined to be updated, the online advertising system updates the new content data according to the UCC-related online service in the database in operation S730.

For still another example, when the new content data according to the event promotion online service is determined to be updated, the online advertising system updates the new content data according to the event promotion online service in the database in operation S730.

For yet another example, when the new content data according to the real-time information online service is determined to be updated, the online advertising system updates the new content data according to the real-time information online service in the database in operation S730.

Also, when the new content data is not determined to be updated, the online advertising system re-requests a transmission of the new content data to the system for providing an online service in operation S740.

For example, when the new content data according to the user evaluation online service is not determined to be updated, the online advertising system re-requests a transmission of the new content data according to the user evaluation online service to the system for providing an online service in operation S740.

For another example, when the new content data according to the UCC-related online service is not determined to be updated, the online advertising system re-requests a transmission of the new content data according to the UCC-related online service to the system for providing an online service in operation S740.

For still another example, when the new content data according to the event promotion online service is not determined to be updated, the online advertising system re-requests a transmission of the new content data according to the event promotion online service to the system for providing an online service in operation S740.

For yet another example, when the new content data according to the real-time information online service is not determined to be updated, the online advertising system re-requests a transmission of the new content data according to the real-time information online service to the system for providing an online service in operation S740.

Referring again to FIG. 6, the online advertising system controls the updated new content data to be reflected in the advertising data associated with the online service in real time. Specifically, the online advertising system controls the updated new content data to be reflected in the advertising data associated with the online service in real time depending on whether to expose the advertisement with respect to the updated new content data in operation S640.

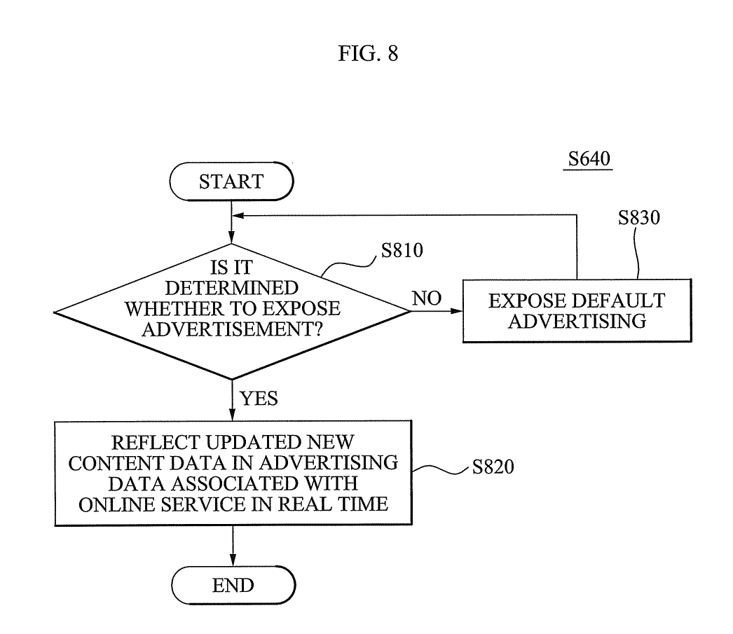

Hereinafter, a method of reflecting the updated new content data in the advertising data associated with the online service in real time is described in greater detail with reference to FIG. 8.

FIG. 8 is a flowchart illustrating an example of a method of reflecting updated new content data in advertising data associated with an online service in real time according to another exemplary embodiment of the present invention.

Referring to FIG. 8, in operation S810, the online advertising system determines whether to expose the advertisement of the updated new content data.

When whether to expose the advertisement with respect to the updated new content data is determined, the online advertising system controls the updated new content data to be reflected in the advertising data associated with the online service in real time in operation S820.

For example, when the online service is a movie service, and whether to expose an advertisement with respect to movie review data updated according to the movie service is determined, the online advertising system controls the updated movie review data to be reflected in advertising data associated with the movie service in real time in operation S820.

For another example, when the online service is a service of providing UCC, and whether to expose an advertisement with respect to UCC data updated according to the service of providing UCC is determined, the online advertising system controls the updated UCC data to be reflected in advertising data associated with the service of providing UCC in real time in operation S820.

For still another example, when the online service is an online board service, and whether to expose an advertisement with respect to reply data updated according to the online board service is determined, the online advertising system controls the updated reply data to be reflected in advertising data associated with the online board service in real time in operation S820.

Also, in the online advertising system, the advertising data includes an opinion registration function. The online advertising system may control opinion data, registered based on the opinion registration function, to be reflected in the advertising data in real time.

When whether to expose the advertisement with respect to the updated new content data is not determined, the online advertising system exposes a default advertisement to the advertising data associated with the online service in operation S830.

The exemplary embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

According to the present invention, an online advertising method and system reflects update of a database due to new content data, generated in an online service, in advertising data associated with the online service in real time.

Also, according to the present invention, an online advertising method and system, when data such as a rating and review with respect to a movie is updated in a movie service, reflects the updated data in advertising data associated with the updated data in real time.

Also, according to the present invention, an online advertising method and system reflects UCC in advertising data associated with the UCC in real time in a UCC service.

Also, according to the present invention, an online advertising method and system, when a posting on a board or reply message is updated, exposes the updated posting or reply message to advertising data associated with the updated posting or reply message in real time.

Also, according to the present invention, an online advertising method and system enables a reply function with respect to advertising data to be performed.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Further, as used herein the term “plurality” refers to at least two elements. Additionally, like numbers refer to like elements throughout.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. Section 112, sixth paragraph, unless the element is expressly recited using the phrase “means for” or, in the case of a method claim, the element is recited using the phrase “step for.”

What is claimed is:

1. An online advertising method, comprising the steps of:
identifying new content data associated with an online service;
updating a database with at least some of the new content data; and
automatically reflecting changes in the database in advertising data associated with the online service.

2. The online advertising method of claim 1, wherein the step of updating comprises the steps of:
determining whether updates of the database with the new content data is necessary, based on at least one predetermined rule; and
updating the database with at least some of the new content data in accordance with result of the determination.

3. The online advertising method of claim 1, wherein the changes in the database is automatically reflected in substantially real time.

4. The online advertising method of claim 1, further comprising the step of:
determining whether exposure of an advertisement associated with the updated new content data is necessary, based on at least one predetermined rule,
wherein the step of automatically reflecting comprises the step of:
automatically reflecting changes in the database in advertising data associated with the online service.

5. The online advertising method of claim 4, further comprising the step of:
exposing the advertising data associated with the online service as a default advertisement if the determination of exposure is not made.

6. The online advertising method of claim 1, wherein the step of automatically reflecting comprises the step of:
reflecting newly-posted data with respect to a board in the advertising data associated with the online service in real time, when the updated new content data is the newly-posted data with respect to the board, the board being associated with the advertising data.

7. The online advertising method of claim 1, wherein the step of automatically reflecting comprises the step of:
reflecting user-created content (UCC) data in the advertising data associated with the online service in real time, when the updated new content data is the UCC data, the UCC data being associated with the advertising data.

8. The online advertising method of claim 1, wherein the step of automatically reflecting comprises the step of:
reflecting opinion registration data with respect to a posting on a board in the advertising data associated with the online service in real time, when the updated new content data is the opinion registration data, the board being associated with the advertising data.

9. The online advertising method of claim 8, wherein the advertising data includes an opinion registration function, and
the online advertising method further comprises the step of:
reflecting opinion data, registered based on the opinion registration function, in the advertising data in real time.

10. One or more computer-readable media having stored thereon a computer program that, when executed by one or more processors, causes the one or more processors to perform acts including:
identifying new content data associated with an online service;
updating a database with at least some of the new content data; and
automatically reflecting changes in the database in advertising data associated with the online service.

11. An online advertising system, comprising:
an online service providing component configured to provide an online service;
an update component configured to update a database with at least some of new content data associated with the online service; and
an advertising management component configured to automatically reflect changes in the database in advertising data associated with the online service.

12. The online advertising system of claim 11, further comprising:
a determination component configured to determine whether updates of the database with the new content data is necessary, based on at least one predetermined rule, and
wherein the update component updates the database with at least some of the new content data in accordance with result of the determination.

13. The online advertising system of claim 11, wherein the changes in the database is automatically reflected in substantially real time.

14. The online advertising system of claim 11, further comprising:
an advertising exposure determination component configured to determine whether exposure of an advertisement associated with the updated new content data is necessary, based on at least one predetermined rule, the advertising management component automatically reflects changes in the database in advertising data associated with the online service.

15. The online advertising system of claim 14, wherein the advertising exposure determination component exposes a default advertisement to the advertising data associated with the online service, if the determination of exposure is not made.

16. The online advertising system of claim 11, wherein the advertising management component manages the online advertisement to reflect newly-posted data with respect to a board in the advertising data associated with the online service in real time, when the updated new content data is the newly-posted data with respect to the board, the board being associated with the advertising data.

17. The online advertising system of claim 11, wherein the advertising management component manages the online advertisement to reflect UCC data in the advertising data associated with the online service in real time, when the updated new content data is the UCC data, the UCC data being associated with the advertising data.

18. The online advertising system of claim 11, wherein the advertising management component manages the online advertisement to reflect opinion registration data with respect to a posting on a board in the advertising data associated with the online service in real time, when the updated new content data is the opinion registration data, the board being associated with the advertising data.

19. The online advertising system of claim 18, wherein the advertising data includes an opinion registration function, and the advertising management component manages the online advertisement to reflect opinion data, registered based on the opinion registration function, in the advertising data associated with the online service in real time.
